(19) United States
(12) Patent Application Publication
(10) Pub. No.: US 2015/0227889 A1
(43) Pub. Date: Aug. 13, 2015

(54) CONTRACT MANAGEMENT USING IN-MEMORY DATABASE SYSTEMS

(71) Applicant: Kumar Vikas, Bangalore (IN)

(72) Inventor: Kumar Vikas, Bangalore (IN)

(21) Appl. No.: 14/177,523

(22) Filed: Feb. 11, 2014

(51) Int. Cl. G06Q 10/08; G06Q 30/06

(52) U.S. Cl. CPC G06Q 10/0875; G06Q 30/0641

(57) ABSTRACT

One example of contract management using in-memory database systems includes an in-memory database computer system which receives an input including pricing parameters associated with a future contract for future purchases of an item. The system accesses an in-memory database storing a history of transactions associated with past purchases of the item under an existing contract. The system retrieves, from the in-memory database, the history of transactions including multiple past instances. A quantity of the item at a price was purchased at each past instance. The system determines a first purchasing value that represents the past purchases of the item. The system determines, using the pricing parameters associated with the future purchases of the item, a second purchasing value that represents the future purchases of the item. The system compares the first purchasing value and the second purchasing value, and provides a result of the comparing to the client computer system.

### TECHNICAL FIELD

This disclosure relates to managing data stored on an in-memory database.

### BACKGROUND

Business entities include vendors and purchasers that contract with each other for goods, services, or both. A business entity, e.g., a purchaser, can track performance under a contract using computer systems. For example, the purchaser can store, in a computer system, a quantity of items purchased from a vendor and a price per item to the vendor from the beginning of the contract until a present time. The purchaser can similarly store, in the computer system, a quantity of the purchaser's items sold, each purchaser's item including a purchased item, and a price received per purchaser's item for a similar duration. The purchaser can compare the total price paid for the item and the price received for the purchaser's item during the duration to determine a profitability of the contract with the vendor. Based on the profitability, the purchaser can manage the contract, e.g., by extending the same contract, renegotiating the contract to include different terms, or canceling the contract.

Contracts with vendors can sometimes be very complex and cover quantities of multiple different items procured at different frequencies over a duration for different costs and different levels of discounts. The quality and speed with which business entities make important business decisions can often depend on the ease with the business entities can access the data associated with the contracts.

### SUMMARY

This disclosure describes computer-implemented method, computer-readable media, and computer systems for contract management using in-memory database systems.

Certain aspects of the subject matter described here can be implemented as a computer-implemented method. An in-memory database computer system receives an input including pricing parameters associated with a future contract for future purchases of an item through a data network from a client computer system that connects the in-memory database computer system and the client computer system. In response to receiving the input, the in-memory database computer system accesses an in-memory database storing a history of transactions associated with past purchases of the item under an existing contract. The in-memory database is connected to the in-memory database computer system through the data network. The in-memory database computer system retrieves, from the in-memory database, the history of transactions including multiple past instances, where a quantity of the item at a price was purchased at each past instance. The in-memory database computer system, determines using the history of transactions, a first purchasing value that represents the past purchases of the item. The in-memory database computer system determines, using the pricing parameters associated with the future purchases of the item, a second purchasing value that represents the future purchases of the item. The in-memory database computer system compares the first purchasing value and the second purchasing value, and provides a result of the comparing to the client computer system.

This, and other aspects, can include one or more of the following features. The history of transactions including the multiple past instances can be distributed across multiple related tables in the in-memory database. The retrieving the history of transactions can include retrieving the history of transactions from the multiple related tables. The in-memory database computer system can receive, from a pricing engine that is separate from the client computer system, a current market price of the item. The in-memory database computer system can determine that the current market price of the item is different from a price of the item specified in the existing contract. The in-memory database computer system can provide, to the client computer system, a notification of a difference between the current market price of the item and the price of the item specified in the existing contract.

Determining that the current market price of the item is different from a price of the item specified in the existing contract can include determining that the current market price of the item is less than the price of the item specified in the existing contract. A notification to renegotiate the existing contract to reflect the current market price of the item can be provided. The future contract can be a contract to become effective upon expiration of the existing contract. The pricing parameters associated with the future contract for purchases of the item can include one or more of a quantity of items to be purchased under the future contract, a purchasing cost, purchasing discounts, inventory costs to store the item, or delivery costs to transport the item. To determining the second purchasing value that represents the future purchases of the item using the pricing parameters associated with the future purchases of the item, the in-memory database computer system can determine a purchasing discount included in the pricing parameters, and apply the purchasing discount to the past purchases included in the history of transactions. To determine the second purchasing value that represents the future purchases of the item using the pricing parameters associated with the future purchases of the item, the in-memory database computer system can determine a quantity of items to be purchased under the future contract and the purchasing cost included in the pricing parameters, and divide the purchasing cost by the quantity of items. To determine the first purchasing value that represents the past purchases of the item, the in-memory database computer system can determine, from the history of transactions eight total quantity of the item purchased, determine, from the history of transactions, a total price paid for the item, and divide the total price paid by the total quantity. The in-memory database computer system can determine the total quantity from multiple purchase orders stored in one or more related tables in the in-memory database. The in-memory database computer system can determine the total price paid for the item from multiple invoices stored in one or more related tables in the in-memory database. The in-memory database computer system can compare the pricing parameters associated with a future contract for purchases of an item and the history of transactions including the multiple past instances under the existing contract. The in-memory database computer system can determine a pricing scheme for the item under the future contract that is more beneficial to the purchaser relative to a pricing scheme for the item under the existing contract in response to comparing the pricing parameters associated with a future contract for purchases of an item and the history of transactions including the past instances under the existing contract. The in-memory database computer system can provide the pricing scheme for the item under the future contract to the client computer system. To provide a result of the comparing, the in-memory database computer system can generate a report including the result of the comparing and provide the report to the client computer system. The in-memory database computer system can provide, to the client computer system a user interface configured to receive the input including the pricing parameters. The in-memory database computer system can't receive the input including pricing parameters associated with the future contract for purchases of the item through the user interface.

Certain aspects of the subject matter described here can be implemented as a non-transitory computer-readable medium storing instructions executable by one or more processors of an in-memory database computer system to perform operations described here. Certain aspects of the subject matter described here can be implemented as an in-memory database computer system including an in-memory database storing a history of transactions associated with past purchases of an item under an existing contract, one or more processors connected to the in-memory database, and a computer-and readable medium storing instructions executable by the one or more processors to perform operations described here.

While generally described as computer-implemented software embodied on tangible media that processes and transforms the respective data, some or all of the aspects may be computer-implemented methods or further included in respective systems or other devices for performing this described functionality. The details of these and other aspects and implementations of the present disclosure are set forth in the accompanying drawings and the description below. Other features and advantages of the disclosure will be apparent from the description and drawings, and from the claims.

### BRIEF DESCRIPTION OF THE DRAWINGS

FIG. 1 is a schematic diagram showing an example in-memory database computer system connected to a client computer system through a data network.

FIG. 2 is a flowchart of an example process for contract management using the in-memory database computer system.

FIG. 3 is a flowchart of an example process for receiving contract management input.

FIG. 4 is a schematic diagram of a user interface for providing pricing parameters for future purchases of an item.

FIG. 5 is an example report showing savings.

Like reference numbers and designations in the various drawings indicate like elements.

### DETAILED DESCRIPTION

This disclosure describes computer-implemented method, computer-readable media, and computer systems for contract management using in-memory database systems. Business entities (e.g., corporations, small businesses, or other business entities) employ procurement teams which, in some instances, develop computer software application for procurement. For example, a business entity's procurement team can develop shopping carts, purchase orders, or other computer software applications for procurement of materials for the business entity. To do so, the procurement team can implement computer systems that track procurement through business objects, e.g., purchase order business objects that track quantities of items, invoice business objects that track prices paid for items, other business objects, or combinations of them. The business entity can store the pricing data collected through the various business objects in computer-readable storage media. One or more such computer-readable storage media can additionally store contract terms that define a contract between the business entity and a vendor from whom the business entity procures some or more or all of the items.

At or near the expiration of an existing contract with a vendor, the business entity can enter into a future contract with the vendor under the same terms as the existing contract, renegotiate with the vendor to obtain more favorable contract terms, or not enter into a future contract with the vendor. The techniques described in this disclosure can be implemented, in conjunction with in-memory database systems that store pricing data, to enable the business entity to make such contract management determinations. In some implementations, the techniques can be implemented to provide, to the business entity and in real-time, changes to realization (e.g., profits, losses, or both) that the business entity will incur by changing pricing parameters associated with one or more items. The techniques can provide the business entity the capability to predict the impact on profitability with changes to the pricing parameters. The business entity can make contract management decisions, e.g., decide to renew or renegotiate the contract, based on the provided capability in real-time and on-the-fly. In other words, storing the pricing data and other contract-related data on an in-memory database can significantly improve the speed at which the business entity can access the pricing data and compare pricing parameters associated with a future contract with those associated with an existing contract to make the contract management decisions. Some implementations of the techniques described here can provide suggestions to the business entity to renew or renegotiate a contract based, in part, upon past usage of the existing contract, e.g., consumption. The prices can be compared with real-time exchange prices. In response to such comparison, savings/loss generated by introducing the current, market rate over the previously negotiated contract prices can be determined.

As described below, in-memory database computer systems can be implemented in conjunction with in-memory databases to implement such techniques. Example techniques implemented by the in-memory database computer systems in conjunction with in-memory database computer systems that store pricing data are described below. The example techniques, alternatively or in addition, can be implemented by computer systems in conjunction with other databases that store the pricing data. In some implementations, some portions of the pricing data can be stored on in-memory databases while other portions can be stored on other databases. Similarly, some portions of the techniques described below can be implemented using in-memory database computer systems that operate as analytical engines built into in-memory databases, while other portions can be implemented using other computer systems that operate separately from the in-memory databases and/or that operate in conjunction with the other databases.

Further, example techniques are described below from the perspective of a purchaser business entity. The example techniques can, in general, be implemented by any business entity, e.g., a vendor, attempting to make contract management decisions. In addition, pricing parameters include several variables (e.g., price, quantity, discounts, delivery conditions) associated with each of several items that a business entity procures from another business entity. For ease of understanding, example techniques are described below in the context of one item associated with multiple pricing parameters. In particular, example techniques are described comparing one combination of pricing parameters of one item in an existing contract with a similar (or same) combination of pricing parameters for the same item in a future contract. The in-memory database computer system described below can develop multiple combinations of pricing parameters for multiple items under existing and future contracts, and compare the combinations under the existing and future contracts. For example, the in-memory database computer system can compare the a first combination under an existing contract with a second, different combination under a future contract (or vice versa), compare the first combination under the existing contract with multiple different combinations under the future contract (or vice versa), or combinations of them. Accordingly, some examples of pricing parameters that affect contract management decisions are described below.

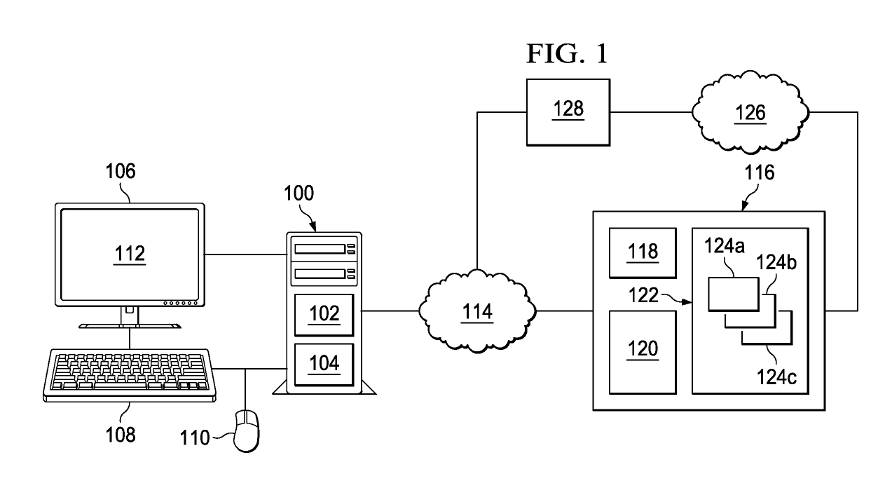

FIG. 1 is a schematic diagram showing an example in-memory database computer system connected to a client computer system through a data network to implement contract management using in-memory database systems. In some implementations, a client computer system 100 is connected to an in-memory database computer system 116 through one or more data networks 114, e.g., the Internet. The client computer system 100, e.g., a desktop computer, a laptop computer, a tablet computer, a smartphone, a personal digital assistant (PDA), or other computer system, includes a computer-readable medium 102 storing computer instructions executable by data processing apparatus 104 (e.g., one or more processors) to perform operations including communicating with the in-memory database computer system 116 and other computer systems over the data network 114. The client computer system 100 is connected to a display device 106 (e.g., a CRT or LCD monitor, a touchscreen, or other display device) and to input devices (e.g., a keyboard 108, a mouse 110, a stylus, or other input devices).

The in-memory database computer system 116 includes a computer-readable medium 118 storing computer instructions executable by data processing apparatus 120 (e.g., one or more processors) to perform operations. The operations include, e.g., storing pricing parameters associated with contracts in an in-memory database 122, e.g., in multiple related tables, e.g., a first table 124a, a second table 124b, a third table 124c, and/or other tables. In some implementations, the in-memory database computer system 116 and/or certain of its components may be integrated with the in-memory database 122 so that, for instance, processing (e.g., all or partial) may be performed directly on in-memory data with processing results passed (e.g., via a communication channel) directly to the client computer system 100. In some implementations, the in-memory database 122 can be located external to the in-memory database computer system 116 and communicably coupled to one or more of the in-memory database computer system 116 and/or the client computer system 100 through the data network 114. The in-memory database 122 can include integrated processing, i.e., all business and/or analytic operations done in processing memory. Moreover, content from business content sources (e.g., pricing parameters) may be replicated from one or more transactional systems (e.g., coupled to the data network 114 or other network) to the in-memory database 122 immediately. Thus, the in-memory database 122, in some aspects, can handle the analytical systems for all business data in real-time, as opposed to, for instance, computational processing systems that have separate transactional and analytical systems that connect through relational databases (i.e., relational databases stored on magnetic memory that require a process, e.g., ETL, to transfer data from one system to another not in real time but with a delay of an hour, day, week, or longer).

In some implementations, the in-memory database 122 can expose business data and capabilities to improve an end-solution for end users (e.g., the client computer system 100 or other end users). The in-memory database 122 can reside on top of a computational engine (e.g., in the in-memory database computer system 116 or otherwise) that facilitates fast manipulations on large amounts of business data and/or replication of entire business suite information. Thus, in some implementations, the in-memory database 122 can provide for one or more or all of the following design principles/concepts: business data in real-time (e.g., GUI patterns for constantly updated business data); well modeled tables and data cubes (e.g., in order to provide semantic services); a highly parallelized computational engine (e.g., for computationally intensive GUI patterns such as real time alerts and/or suggestions); close coupling of business logic and business data (e.g., eliminating indexing and caching).

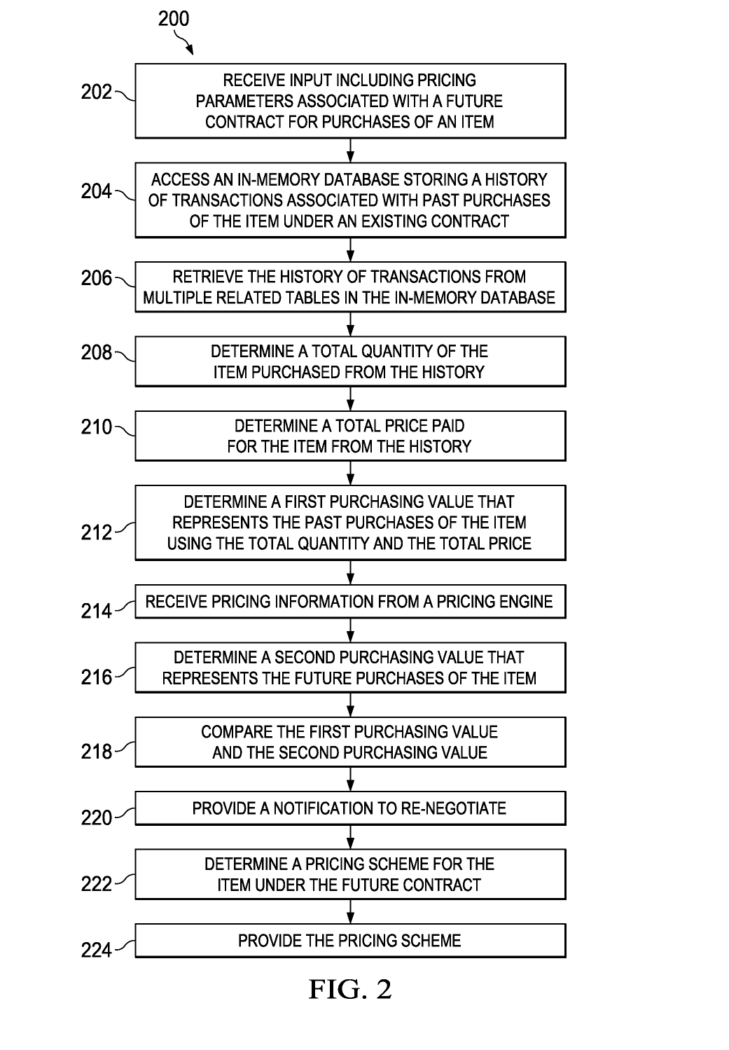

FIG. 2 is a flowchart of an example process 200 for contract management using the in-memory database computer system 116. In some implementations, the in-memory database computer system 116 can implement the process 200. At 202, an input including pricing parameters associated with a future contract for future purchases of an item is received. In some implementations, the in-memory database computer system 116 receives the input including the pricing parameters from the client computer system 100. The pricing parameters represent procurement details of the item that a business entity, e.g., a purchaser, wants to include in a future contract with another business entity, e.g., a vendor. The pricing parameters include a price per item, a quantity of the item, a duration of the future contract, header discounts, delivery conditions, delivery costs, inventory costs, other pricing parameters, or combinations of them. Pricing parameters can, alternatively or in addition, include indirect cost terms including, e.g., payment terms, incoterms or both. The indirect cost parameters associated with contract items can be adjusted into the price to arrive at net price and to compare even the impact of change of these parameters on net savings/loss. For example, a user of the client computer system 112 can provide the pricing parameters through a user interface 112 displayed in the display device 106.

At 204, an in-memory database storing a history of transactions associated with past purchases of the item under an existing contract is accessed. In some implementations, the in-memory database computer system 12 accesses the in-memory database 122 that stores the history of transactions. At 206, the history of transactions is retrieved from the in-memory database 122. In some implementations, the in-memory database computer system 116 retrieves the history of transactions which include multiple past instances. At each instance, a quantity of the item was purchased at a respective price. The history of transactions can include similar information for other items and/or additional information describing the past purchases of the item, e.g., discount details, delivery information, and other details describing past purchases. The in-memory database computer system 116 can retrieve some or all of the history of transactions from the in-memory database 122. In some implementations, the in-memory database system 116 can retrieve the history of transactions from multiple related tables in the in-memory database 122.

At 208, a total quantity of the item purchased is determined from the history, and, at 210, a total price paid for the item is determined from the history. At 212, a first purchasing value that represents the past purchases of the item is determined using the total quantity and the total price. For example, the first purchasing value represents the price paid for the item during an existing contract. In some implementations, for each item stored in the history of transactions, the in-memory database computer system 116 can determine the total quantity of the item purchased, the total price paid, and the first purchasing value by implementing the pseudo-code shown below:

For each item in the history of transactions:
find the purchase order and invoice created during requested period (e.g., duration of the existing contract);
Add all quantity ordered for procurement in that period

QT=qt₁+qt₂+qt₃ + . . . qtₙ
Add all the purchase value for the quantity ordered in different business document like Purchase Order and Invoice during requested period.

PV=pv₁+pv₂+pv₃ + . . . pvₙ
Find the average price

P_{avg}=PV/Qt

The in-memory database computer system 116 can obtain each quantity ordered (i.e., qt₁, qt₂, . . . , qtₙ) and each price paid (i.e., pv₁, pv₂, . . . , pvₙ) from multiple purchase orders and multiple invoices, respectively, stored in one or more related tables (e.g., the first table 124a, the second table 124b, the third table 124c, and/or other tables) in the in-memory database 122. As shown above, the in-memory database computer system 116 can divide the total price paid by the total quantity purchased to determine the first purchasing value, i.e., the average price paid per item.

In some implementations, the in-memory database computer system 116 can implement the in-memory database's calculation attributes and projection views using the underlying supplier resource management (SRM) transactional table to determine the first purchasing value. By doing so, the in-memory database computer system 116 can leverage the features of the in-memory database 122 to determine the first purchasing value in real-time, i.e., as soon after the in-memory database computer system 116 receives the input to determine the first purchasing value, e.g., from the client computer system 100. Consequently, a speed at which the user of the client computer system 100 views the first purchasing value can be significantly faster than a speed at which the user would receive the first purchasing value were the history of transactions stored in databases other than in-memory databases. This will allow the purchaser to provide a gaming kind of experience to play with various direct pricing/indirect pricing parameters and see their results in real time, thereby allowing the purchaser to apply numerous permutations and combinations to arrive at the pricing parameters that are the most impactful leading to overall savings/least loss/combinations of them.

In some implementations, the in-memory database computer system 116 can provide the first purchasing value to the client computer system 100, e.g., in response to receiving an input for the purchasing value from the user of the client computer system 100. Having received the first purchasing value that represents the past purchases of the item, e.g., under an existing contract, the user of can make contract management decisions including, e.g., extend the contract under the same terms, renegotiate the terms of the existing contract, or cancel the contract. In some implementations, the user can make the determination as the expiration of the existing contract nears. For example, the in-memory database computer system 116 can identify that the existing contract is scheduled to expire ahead of time (e.g., days, weeks, or months ahead of time), and provide a notification to the client computer system 100. Alternatively, or in addition, the user can make the determination in response to the in-memory database computer system 116 monitoring a market value of the item, as described below.

At 214, pricing information is received from a pricing engine. In some implementations, a pricing engine 128 is connected either to the in-memory database computer system 122 or the client computer system 100 (or both) over the data networks 126 or 114 (or both), respectively. The pricing engine 128 can be implemented as a computer system that is separate from (or integrated with) the in-memory database computer system 116 and that tracks the market to determine a current market price of the item. The pricing engine 128 can periodically (i.e., at a specified time interval) provide the current market price of the item to the in-memory database computer system 116, which, in turn, can determine that the current market price is different from (e.g., lesser or greater than) the price being paid for the item under the existing contract. The in-memory database computer system 116 can provide, e.g., periodically, a notification of the difference to the client computer system 100. For example, in response to determining that the current market price of the item is less than the price of the item specified in the existing contract, the in-memory database computer system 116 can provide the notification to renegotiate the existing contract to reflect the current market price of the item.

In some situations, the in-memory database computer system 116 can determine that the existing contract is structured such that a current market price less than the price of the item specified in the existing contract would not result in an increased profitability for the business entity. In such situations, the in-memory database computer system 116 can provide the notification that the current market price is less than the price specified in the existing contract and a notification of the absence of profitability under the current market price.

In situations in which a future contract is being evaluated, the user can provide, to the in-memory database computer system 116, a combination (or combinations) of pricing parameters that reflect differences between the contract terms under the new and existing contract. In one example, the user of the client computer system 100 can specify that the quantity of the item to be purchased during a specified time period under the future contract is the same as the quantity of the item that was purchased during the same time period under the future contract, but that a purchasing discount (e.g., header discount), that was not available under the existing contract, is to be applied under the future contract. In another example, the user can specify a quantity for the future contract that is different from the quantity for the existing contract, and specify different delivery terms (e.g., delivery directly to a warehouse instead of the purchaser's factory). In a further example, the user can specify a staggered pricing scheme for the items, i.e., the first X items at a first price, the subsequent Y items at a second price that is different from the first price, the subsequent Z items at a third price that is different from the second price, and so on. In another example, the pricing scheme can include a staggered discount such as a first percentage discount for the first X items, a second percentage discount for the subsequent Y items, a third percentage discount for the subsequent Z items, and so on.

The user can identify several such combinations of pricing parameters for several items under the future contract, and provide each combination to the in-memory database computer system 116. The combinations can be complex, e.g., as the number of items involved in the contract increases. The user can develop one or more combinations, such as those described above, for individual items, subsets of items, or all items involved in the contract. As described below, the in-memory database computer system 116, working in conjunction with the in-memory database 122, can rapidly provide results of a comparison of the pricing parameters under the new and existing contracts to the user of the client computer system 100 allowing the user to experiment with several combinations of pricing parameters until the user arrives at a combination that is most beneficial, e.g., profitable, to the user.

At 216, a second purchasing value that represents the future purchases of the item is determined. In some implementations, in response to receiving a combination (or combinations) of pricing parameters as described above, the in-memory database computer system 116 can determine the second purchasing value. The user of the client computer system 100 can provide the combination to the in-memory database computer system 116, e.g., in response to determining that an existing contract is scheduled to expire, in response to determining that a current market value of an item is less than a value, e.g., the first purchasing value, currently being paid for the item, based on a cost of negotiating, combinations of them, or in response to other reasons.

In the example above in which the user specified that a purchasing discount (e.g., header discount), that was not available under the existing contract, is to be applied under the future contract, the in-memory database computer system 116 can determine the second purchasing value by applying the purchasing discount to the past purchases included in the history of transactions. In some implementations, the in-memory database computer system 116 can determine the purchasing discount while, in other implementations, the user of the client computer system 100 can specify the purchasing discount. In an example in which a quantity and/or a price for the future contract that is different from the quantity and/or for the existing contract, the in-memory database computer system 116 can determine the second purchasing value by dividing the price under the future contract by the quantity under the future contract. In the example in which the user specified a staggered pricing scheme for the items, the in-memory database computer system 116 can determine a second purchasing value that represents an average price to be paid for the item under the future contract.

In this manner, for each of several combinations of pricing parameters received for one or more items involved in the future contract, the in-memory database computer system 116 can determine respective second purchasing values in real-time and on-the-fly, i.e., as the user is providing the combination of pricing parameters. Having determined the second purchasing value for each combination, the in-memory database computer system 116 can provide recommendations to the user regarding contract management decisions, as described below.

At 218, the first purchasing value and the second purchasing value are compared. In some implementations, the in-memory database computer system 116 can compare the numerical value that represents the first purchasing value and the numerical value that represents the second purchasing value. For example, the in-memory database computer system 116 can determine that the quantity under the future contract is the same as the quantity under the existing contract, and that the discount on header and item is 5% more under the future contract relative to the existing contract. Applying the pricing parameters under the future contract, the in-memory database computer system 116 can determine a net price and a target purchase value for the item under the future contract. In another example, the in-memory database computer system 116 can determine that the quantity under the future contract is more or less than the quantity under the future contract. In this example, the in-memory database computer system 116 can determine a target purchase value for the new quantity under the pricing parameters of the existing contract and the future contract, and compare the two target purchase values.

At 220, the notification to re-negotiate is provided. For example, if the in-memory database computer system 116 determines that the second purchasing value which represents future purchases of the item, and which the in-memory database computer system 116 determines based, in part, on the pricing information received from the pricing engine 128, is less than the first purchasing value which represents past purchases of the item, then the in-memory database computer system 116 can provide a notification to be displayed in a user interface, e.g., the user interface 112, in the display device 106 of the client computer system 100.

At 222, a pricing scheme for the item under the future contract is determined. In some implementations, the in-memory database computer system 116 can compare the pricing parameters associated with the future contract for purchases of the item, and the history of transactions which includes the multiple past instances under the existing contract by implementing operations such as those described above. The in-memory database computer system 116 can determine a pricing scheme for the item under the future contract that is more beneficial to the purchaser relative to a pricing scheme for the item under the existing contract in response to such a comparison. For example, the in-memory database computer system 116 can determine a pricing scheme under the future contract that would be more profitable for the business entity than the pricing scheme under the existing contract. The in-memory database computer system 116 can determine a pricing scheme in which a fewer quantity of the item relative to the existing contract is purchased at the same price as the existing contract, the same quantity as the existing contract is purchased at a lesser price relative to the existing contract, a discount is applied to all or portions of the items that result in an increased profitability relative to the existing contract, the items are purchased at staggered prices, or combinations of them.

In another example, the in-memory database computer system 116 can determine a pricing scheme that is based on a trade-off between price and quality. That is, the in-memory database computer system 116 can determine a first pricing scheme in which the business entity can obtain a high quality item at a higher price from a different vendor under a future contract relative to an existing contract. The system 116 can determine that doing so will result in fewer quantities of the item being purchased (e.g., due to fewer quality control issues) resulting in more beneficial pricing. Alternatively, the business entity can obtain a lower quality item at a cheaper price from a different vendor under a future contract relative to an existing contract on the basis that doing so any losses due to quality control issues are less than savings due to lower price. In sum, the in-memory database computer system 116 can identify a combination of pricing parameters under the future contract which result in a purchasing value that represents the cost of the item under the future contract, such purchasing value being less than a corresponding purchasing value under the existing contract determined from the combination of pricing parameters under the existing contract.

The in-memory database computer system 116 can implement these techniques for one or more or all items that are involved in the existing or future contract or both.

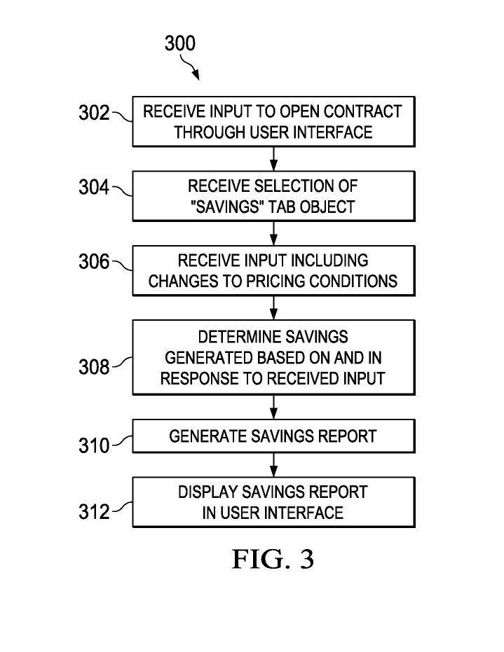

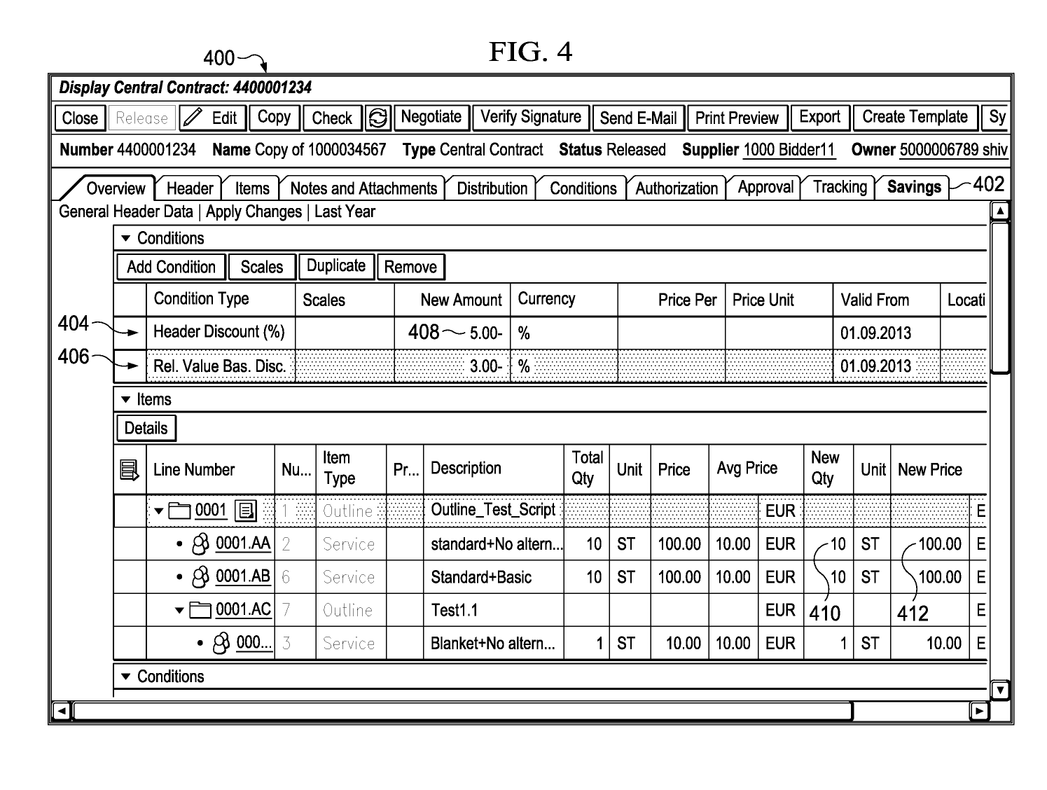

At 224, the pricing scheme is provided. In some implementations, the in-memory database computer system 116 can provide a result of comparing the first and second purchasing values to the client computer system 100. To do so, the in-memory database client computer system 116 can generate a report including the result of the comparison and provide the report to the client computer system 100. For example, the report can include a comparison of the target purchase values (described above) under the existing and future contracts, and savings (if any) to be obtained under the future contract relative to the old contract. Alternatively, or in addition, the in-memory database computer system 116 can provide the pricing scheme determined to be more beneficial than the pricing scheme under the existing contract to the client computer system 100. In some implementations, the in-memory database computer system 116 can provide, to the client computer system 100, a user interface (e.g., user interface 112) and display the pricing scheme in the user interface. The in-memory database computer system 116 can, alternatively or in addition, provide a user interface to receive the pricing parameters, as described below with reference to FIGS. 3 and 4.

FIG. 3 is a flowchart of an example process 300 for receiving contract management input. FIG. 4 is a schematic diagram of a user interface 400 for providing pricing parameters for future purchases of an item. In some implementations, the in-memory database computer system 116 can implement process 300 to provide the user interface (e.g., the user interface 400) to the client computer system 100. The client computer system 100 can display the user interface 400 in the display device 106. A user of the client computer system 100 can provide input including the pricing parameters through the user interface 400, as described below.

At 302, input to open a contract is received through a user interface. In some implementations, the client computer system 100 displays a user interface 400 in the display device 106. The in-memory database computer system 116 can provide the user interface 400 to the client computer system 100. In the user interface 400, the in-memory database client computer system 116 can display information associated with an existing contract, e.g., pricing parameters. In some implementations, the user interface 100 can include several tab objects (e.g., an “Overview” tab object, a “Header” tab object, an “Items” tab object, a “Notes and Attachments” tab object, a “Distribution” tab object, a “Conditions” tab object, an “Authorization” tab object, an “Approval” tab object, a “Tracking” tab object, and other tab objects). For example, when a user of the client computer system 100 selects the “Overview” tab object, the in-memory database computer system 116 (or the client computer system 100) can display general information about the contract such as a contract identifier, a supplier identifier, a duration for which the contract is valid, an organization and/or group within the business entity that is procuring the items, a target value for the contract, and other general information. The general information can also include multiple line items, each representing an item being procured under the contract and information about the item, e.g., item identifier, item name, target quantity, price, and other information. The user interface 100 can also include a “Savings” tab object 402, described below.

At 304, a selection of the “Savings” tab object 402 is received. For example, a user of the client computer system 100 can select the “Savings” tab object 402 using an input device. In response, the in-memory database computer system 116 (or the client computer system 100) can display a user interface portion shown in FIG. 4 through which the user of the client computer system 100 can provide pricing conditions for the future contract. The user interface portion can include a percentage header discount object 404, a relative value basic discount object 406, or other objects through which the user can provide pricing parameters associated with the future contract.

At 306, input including changes to pricing conditions is received. For example, in the textbox 408, the user can input “5.00” as the percentage header discount to be applied across all the items in the contract. Alternatively or in addition, the user can input pricing parameters for one or more items involved in the future contract. For example, in the textboxes 410 and 412, the user can input a value that represents a future quantity and a future price, respectively, of a single item. Similarly, the user can provide pricing parameters for one or more other items involved in the future contract.

At 308, savings generated based on the input received at 306 can be determined in response to receiving the input. For example, the client computer system 100 can transmit the pricing parameters received at 306 to the in-memory database computer system 116, which can determine the savings by implementing techniques such as those described above.

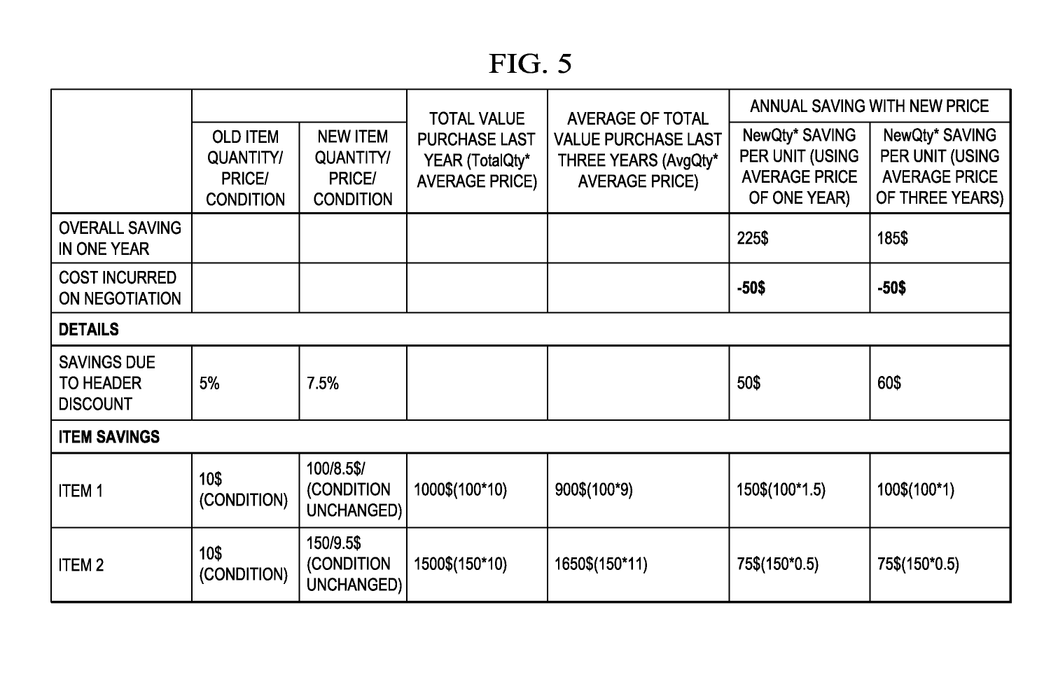

At 310, a savings report can be generated. For example, the in-memory computer system 116 can generate the savings report by implementing techniques such as those described above, and transmit the savings report to the client computer system 100. At 312, the savings report is displayed in the user interface. For example, the client computer system 100 displays the savings report received from the in-memory database computer system 116. An example savings report is shown in FIG. 5. The user of the client computer system 100 (or any business entity) can decide whether the existing contract should be renewed or renegotiated. In some implementations, the in-memory database computer system 116 can include the cost for renegotiation as a pricing parameter to generate the savings report.

Implementations of the subject matter and the operations described in this disclosure can be implemented in digital electronic circuitry, or in computer software, firmware, or hardware, including the structures disclosed in this disclosure and their structural equivalents, or in combinations of one or more of them. Implementations of the subject matter described in this disclosure can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, for example, a machine-generated electrical, optical, or electromagnetic signal that is generated to encode information for transmission to suitable receiver apparatus for execution by a data processing apparatus. A computer storage medium, for example, the computer-readable medium, can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical and/or non-transitory components or media (for example, multiple CDs, disks, or other storage devices).

In some implementations, the operations described in this disclosure can be implemented as a hosted service provided on a server in a cloud computing network. For example, the computer-readable storage media can be logically grouped and accessible within a cloud computing network. Servers within the cloud computing network can include a cloud computing platform for providing cloud-based services. The terms “cloud,” “cloud computing,” and “cloud-based” may be used interchangeably as appropriate without departing from the scope of this disclosure. Cloud-based services can be hosted services that are provided by servers and delivered across a network to a client platform to enhance, supplement, or replace applications executed locally on a client computer. The system can use cloud-based services to quickly receive software upgrades, applications, and other resources that would otherwise require a lengthy period of time before the resources can be delivered to the system.

The operations described in this disclosure can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, for example, an FPGA (field programmable gate array) or an ASIC (application-specific integrated circuit). The apparatus can also include, in addition to hardware, code that creates an execution environment for the computer program in question, for example, code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (for example, one or more scripts stored in a markup language document), in a single file dedicated to the program in question, or in multiple coordinated files (for example, files that store one or more modules, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, for example, an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a Global Positioning System (GPS) receiver, or a portable storage device (for example, a universal serial bus (USB) flash drive), to name just a few. Devices suitable for storing computer program instructions and data include all forms of non-volatile memory, media and memory devices, including by way of example semiconductor memory devices, for example, EPROM, EEPROM, and flash memory devices; magnetic disks, for example, internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this disclosure can be implemented on a computer having a display device, for example, a CRT (cathode ray tube) or LCD (liquid crystal display) monitor, for displaying information to the user, and a keyboard, a pointing device, for example, a mouse or a trackball, or a microphone and speaker (or combinations of them) by which the user can provide input to the computer. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this disclosure can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this disclosure, or any combination of one or more such back-end, middleware, or front-end components. The components of the system can be interconnected by any form or medium of digital data communication, for example, a communication network. Examples of communication networks include a local area network (“LAN”) and a wide area network (“WAN”), an inter-network (for example, the Internet), and peer-to-peer networks (for example, ad hoc peer-to-peer networks).

The computing system can include clients and servers. A client and server are generally remote from each other and typically interact through a communication network.

The relationship of client and server arises by virtue of computer programs running on the respective computers and having a client-server relationship to each other. In some implementations, a server transmits data (for example, an HTML page) to a client device (for example, for purposes of displaying data to and receiving user input from a user interacting with the client device). Data generated at the client device (for example, a result of the user interaction) can be received from the client device at the server.

While this disclosure contains many specific implementation details, these should not be construed as limitations on the scope of any implementations or of what may be claimed, but rather as descriptions of features specific to particular implementations of particular implementations. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. A computer-implemented method comprising:
receiving, at an in-memory database computer system from a client computer system through a data network connecting the in-memory database computer system and the client computer system, an input including pricing parameters associated with a future contract for future purchases of an item;
in response to receiving the input:
accessing, by the in-memory database computer system, an in-memory database storing a history of transactions associated with past purchases of the item under an existing contract, the in-memory database connected to the in-memory database computer system through the data network;
retrieving, by the in-memory database computer system and from the in-memory database, the history of transactions including a plurality of past instances, wherein a quantity of the item at a price was purchased at each past instance;
determining, by the in-memory database computer system and using the history of transactions, a first purchasing value that represents the past purchases of the item;
determining, by the in-memory database computer system and using the pricing parameters associated with the future purchases of the item, a second purchasing value that represents the future purchases of the item;
comparing, by the in-memory database computer system, the first purchasing value and the second purchasing value; and
providing, by the in-memory database computer system to the client computer system, a result of the comparing.

2. The method of claim 1, wherein the history of transactions including the plurality of past instances is distributed across a plurality of related tables in the in-memory database, and wherein retrieving the history of transactions comprises retrieving the history of transactions from the plurality of related tables.

3. The method of claim 1, further comprising:
receiving, by the in-memory database computer system and from a pricing engine that is separate from the client computer system, a current market price of the item;
determining, by the in-memory database computer system, that the current market price of the item is different from a price of the item specified in the existing contract; and
providing, by the in-memory database computer system to the client computer system, a notification of a difference between the current market price of the item and the price of the item specified in the existing contract.

4. The method of claim 3, wherein determining that the current market price of the item is different from a price of the item specified in the existing contract comprises determining that the current market price of the item is less than the price of the item specified in the existing contract, the method further comprising providing a notification to re-negotiate the existing contract to reflect the current market price of the item.

5. The method of claim 1, wherein the future contract is a contract to become effective upon expiration of the existing contract, and wherein the pricing parameters associated with the future contract for purchases of the item include one or more of a quantity of items to be purchased under the future contract, a purchasing cost, purchasing discounts, inventory costs to store the item, or delivery costs to transport the item.

6. The method of claim 5, wherein determining, by the in-memory database computer system and using the pricing parameters associated with the future purchases of the item, a second purchasing value that represents the future purchases of the item comprises:
determining a purchasing discount included in the pricing parameters; and
applying the purchasing discount to the past purchases included in the history of transactions.

7. The method of claim 5, wherein determining, by the in-memory database computer system and using the pricing parameters associated with the future purchases of the item, a second purchasing value that represents the future purchases of the item comprises:
determining a quantity of items to be purchased under the future contract and the purchasing cost included in the pricing parameters; and
dividing the purchasing cost by the quantity of items.

8. The method of claim 1, wherein determining the first purchasing value that represents the past purchases of the item comprises:
determining, from the history of transaction, a total quantity of the item purchased;
determining, from the history of transactions, a total price paid for the item; and
dividing the total price paid by the total quantity.

9. The method of claim 8, wherein determining the total quantity of the item purchased comprises determining the total quantity from a plurality of purchase orders stored in one or more related tables in the in-memory database, and wherein determining the total price paid for the item comprises determining the total price from a plurality of invoices stored in one or more related tables in the in-memory database.

10. The method of claim 1, further comprising:
comparing, by the in-memory database computer system, the pricing parameters associated with a future contract for purchases of an item and the history of transactions including the plurality of past instances under the existing contract;
determining, by the in-memory database computer system, a pricing scheme for the item under the future contract that is more beneficial to the purchaser relative to a pricing scheme for the item under the existing contract, in response to comparing the pricing parameters associated with a future contract for purchases of an item and the history of transactions including the plurality of past instances under the existing contract; and
providing, by the in-memory database computer system to the client computer system, the pricing scheme for the item under the future contract.

11. The method of claim 1, wherein providing, by the in-memory database computer system to the client computer system, a result of the comparing comprises:
generating a report including the result of the comparing; and
providing the report to the client computer system.

12. The method of claim 1, further comprising providing, to the client computer system, a user interface configured to receive the input including the pricing parameters, and wherein receiving the input including pricing parameters associated with a future contract for purchases of the item comprises receiving the pricing parameters through the user interface.

13. A non-transitory computer-readable medium storing instructions executable by one or more processors of an in-memory database computer system to perform operations comprising:
receiving, at an in-memory database computer system from a client computer system through a data network connecting the in-memory database computer system and the client computer system, an input including pricing parameters associated with a future contract for purchases of an item;
in response to receiving the input:
accessing, by the in-memory database computer system, an in-memory database storing a history of transactions associated with past purchases of the item under an existing contract, the in-memory database connected to the in-memory database computer system through the data network;
retrieving, by the in-memory database computer system and from the in-memory database, the history of transactions including a plurality of past instances, wherein a quantity of the item at a price was purchased at each past instance;
determining, by the in-memory database computer system and using the history of transactions, a first pricing scheme for the item under the existing contract;
determining, by the in-memory database computer system and using the pricing parameters associated with the future purchases of the item, a second pricing scheme for the item under the future contract that is more beneficial relative to the first pricing scheme for the item under the existing contract; and
providing, by the in-memory database computer system and to the client computer system, the second pricing scheme.

14. The medium of claim 13, wherein the history of transactions including the plurality of past instances is distributed across a plurality of related tables in the in-memory database, and wherein retrieving the history of transactions comprises retrieving the history of transactions from the plurality of related tables.

15. The medium of claim 13, wherein the future contract is a contract to become effective upon expiration of the existing contract, and wherein the pricing parameters associated with the future contract for purchases of the item include one or more of a quantity of items to be purchased under the future contract, a purchasing cost, purchasing discounts, inventory costs to store the item, or delivery costs to transport the item.

16. The medium of claim 13, wherein the pricing scheme is a cost per item, and wherein determining, by the in-memory database computer system and using the pricing parameters associated with the future purchases of the item, a second pricing scheme for the item under the future contract that is more beneficial relative to the first pricing scheme for the item under the existing contract comprises:
determining that the cost per item under the existing contract;
manipulating the one or more pricing parameters associated with the future purchases of the item to determine a cost per item that is less than the cost per item under the existing contract; and
providing, as the second pricing scheme, the cost per item that is less than the cost per item under the existing contract.

17. The medium of claim 13, wherein providing the second pricing scheme comprises:
generating a report including the second pricing scheme; and
providing the report to the client computer system for display in a user interface.

18. The method of claim 1, further comprising providing, to the client computer system, a user interface configured to receive the input including the pricing parameters, and wherein receiving the input including pricing parameters associated with a future contract for purchases of the item comprises receiving the pricing parameters through the user interface.

19. An in-memory database computer system comprising:
an in-memory database storing a history of transactions associated with past purchases of an item under an existing contract;
one or more processors connected to the in-memory database; and
a computer-readable medium storing instructions executable by the one or more processors to perform operations comprising:
receiving, from a client computer system through a data network, an input including pricing parameters associated with a future contract for purchases of an item;
in response to receiving the input:
accessing an in-memory database storing a history of transactions associated with past purchases of the item under an existing contract, the in-memory database connected to the in-memory database computer system through the data network;
retrieving, from the in-memory database, the history of transactions including a plurality of past instances, wherein a quantity of the item at a price was purchased at each past instance;
determining, using the history of transactions, a first purchasing value that represents the past purchases of the item;
determining, using the pricing parameters associated with the future purchases of the item, a second purchasing value that represents the future purchases of the item;
comparing the first purchasing value and the second purchasing value; and
providing, to the client computer system, a result of the comparing.
